(19) United States
(12) Patent Application Publication
(10) Pub. No.: US 2017/0151938 A1
(43) Pub. Date: Jun. 1, 2017

(54) APPARATUS AND METHOD FOR CONTROLLING CLUTCH IN ENVIRONMENTALLY FRIENDLY VEHICLE

(71) Applicant: HYUNDAI MOTOR COMPANY, Seoul (KR)

(72) Inventors: Tae Ho KIM, Seoul (KR); Hak Sung LEE, Hwaseong-si (KR); Jong Hyun KIM, Yongin-si (KR)

(21) Appl. No.: 15/181,131

(22) Filed: Jun. 13, 2016

(30) Foreign Application Priority Data
Nov. 30, 2015 (KR) 10-2015-0169391

(51) Int. Cl. B60W 20/10; B60K 6/387; B60K 6/46; F16D 48/06

(52) U.S. Cl. CPC B60W 20/10; F16D 48/06; B60K 6/387; B60K 6/46; Y10S 903/946; B60Y 2200/92; B60Y 2300/182; B60Y 2300/192; B60Y 2300/42; B60Y 2400/428; B60W 2510/0208; B60W 2510/0241; B60W 2710/021

(57) ABSTRACT

An apparatus for controlling a clutch in an environmentally friendly vehicle includes: a clutch configured to transfer or block power generated in a power generator; a clutch actuator configured to measure a pressure of the clutch using a pressure sensor embedded therein; and a controller configured to compare the pressure measured through the pressure sensor with reference data and inspect whether or not abrasion occurs in the clutch depending on the comparison.

### CROSS-REFERENCE TO RELATED APPLICATION

This application is based on and claims the benefit of priority to Korean Patent Application. No. 10-2015-0169391, filed on Nov. 30, 2015 in the Korean Intellectual Property Office, the disclosure of which is incorporated herein in its entirety by reference.

### TECHNICAL FIELD

The present disclosure relates to an apparatus and a method for controlling a clutch in a hybrid vehicle in which an abrasion state of a clutch disk is confirmed and driving of the clutch is compensated for.

### BACKGROUND

In an environmentally friendly vehicle such as a hybrid vehicle, various power transfer structures may be configured using an engine and a motor as power sources. The hybrid vehicle is driven in an electric vehicle (EV) mode in which it is driven using only power of the motor or is driven in a hybrid electric vehicle (HEV) mode in which it is driven using both of power of the engine and power of the motor.

The hybrid vehicle includes a separate engine clutch actuator mounted in order to actuate an engine clutch intermitting power between the engine and the motor. The engine clutch actuator has been used in a double clutch transmission (DCT) based hybrid system.

The DCT based hybrid vehicle requires structures of the engine clutch actuator and a clutch slave cylinder (CSC) in order to engage or disengage the engine clutch. When abrasion occurs in the clutch disk, a clutch load is changed depending on clutch characteristics, which has an influence on transfer force of the actuator, which is an actuating apparatus.

In addition, according to the related art, required transfer power of the actuator becomes large due to the abrasion of the clutch disk, and thus, it is very important to inspect an abrasion state of the clutch disk

### SUMMARY

The present disclosure has been made to solve the above-mentioned problems occurring in the prior art while advantages achieved by the prior art are maintained intact.

An aspect of the present disclosure provides an apparatus and a method for controlling a clutch in a hybrid vehicle in which an abrasion state of a clutch disk is confirmed using a pressure sensor of a clutch actuator and driving of the clutch is compensated for on the basis of a confirmation result.

According to an exemplary embodiment in the present disclosure, an apparatus for controlling a clutch in an environmentally friendly vehicle includes: a clutch transferring or blocking power generated in a power generator; a clutch actuator measuring a pressure of the clutch using a pressure sensor embedded therein; and a controller configured to compare the pressure measured through the pressure sensor with reference data and inspect whether or not abrasion occurs in the clutch depending on the comparison.

The clutch may be an engine clutch installed between an engine and a motor and transferring or blocking engine power.

The clutch may be a double clutch transferring power generated in a motor to a transmission or blocking the power transferred to the transmission.

The controller may perform compensation for the abrasion of the clutch when the abrasion occurs in the clutch.

The controller may transmit a rotation command of an actuator motor corresponding to an abrasion amount of the clutch to the clutch actuator.

The reference data may be characteristic information of a clamping load depending on a clamping travel.

The controller may store comparison data between the pressure of the clutch and the reference data in a storage.

According to another exemplary embodiment in the present disclosure, a method for controlling a clutch in an environmentally friendly vehicle includes: actuating a clutch actuator when a driving mode of the environmentally friendly vehicle is switched from a hybrid electric vehicle (HEV) mode into an electric vehicle (EV) mode; measuring a pressure of the clutch using a pressure senor of the clutch actuator; and inspecting whether or not abrasion occurs in the clutch by comparing the pressure of the clutch with reference data.

The method for controlling a clutch in an environmentally friendly vehicle may further include performing compensation for the abrasion of the clutch in the case in which the abrasion occurs in the clutch as an inspection result for whether or not the abrasion occurs in the clutch.

In the performing of the compensation for the abrasion of the clutch, an abrasion amount of the clutch may be calculated on the basis of a comparison result between the pressure of the clutch and the reference data, and a rotation command of an actuator motor corresponding to the calculated abrasion amount of the clutch may be transmitted to the clutch actuator.

The reference data may be characteristic information of a clamping load depending on a clamping travel.

In the inspecting of whether or not the abrasion occurs in the clutch, comparison data between the pressure of the clutch and the reference data may be stored in a storage.

### BRIEF DESCRIPTION OF THE DRAWINGS

The above and other objects, features and advantages of the present disclosure will be more apparent from the following detailed description taken in conjunction with the accompanying drawings.

FIG. 1 is a block diagram illustrating an apparatus for controlling a clutch in environmentally friendly vehicle according to an exemplary embodiment in the present disclosure.

FIG. 2 is a graph illustrating a characteristic curve of a clutch disk-diaphragm spring related to the present disclosure.

FIG. 3 is a flow chart illustrating a method for controlling a clutch in an environmentally friendly vehicle according to an exemplary embodiment in the present disclosure.

### DETAILED DESCRIPTION

Hereinafter, exemplary embodiments in the present disclosure will be described in detail with reference to the accompanying drawings.

In the present disclosure, a case in which an abrasion state of an engine clutch disk is inspected using a pressure sensor embedded in an engine clutch actuator and compensation for abrasion of an engine clutch is performed depending on the inspected abrasion state of the engine clutch disk in a double clutch transmission (DCT) based hybrid vehicle (an environmentally friendly vehicle) will be described by way of example in order to assist, in the understanding of the present disclosure.

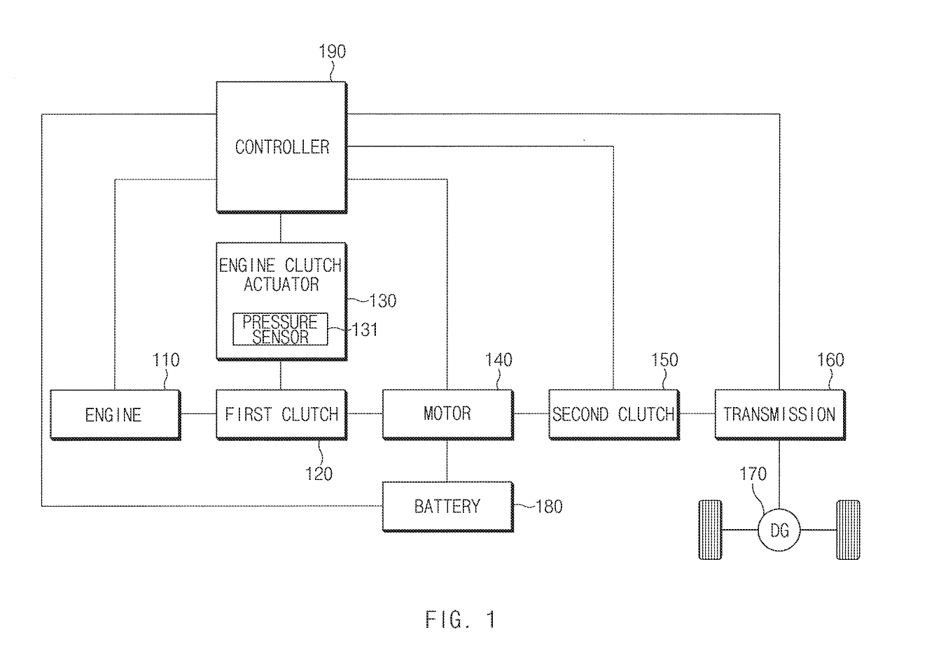

FIG. 1 is a block diagram illustrating an apparatus for controlling a clutch in an environmentally friendly vehicle according to an exemplary embodiment in the present disclosure.

The apparatus for controlling a clutch in an environmentally friendly vehicle includes an engine 110, a first clutch 120, an engine clutch actuator 130, a motor 140, a second clutch 150, a transmission 160, a differential gear (DG) 170, a battery 180, and a controller 190. The environmentally friendly vehicle uses the engine 110 and the motor 140 as a power generator generating power.

The engine 110 burns a fuel to generate power required to drive the vehicle. The engine 110 is cranked to an external power source (for example, a start-up electric motor) to start driving. An output torque (an engine torque or engine power) of the engine 110 is controlled depending on a control of the controller 190.

The first clutch 120 is an engine clutch disposed between the engine 110 and the motor 140 and intermitting the power (the output torque) of the engine 110.

The engine clutch actuator 130 controls an operation of the first clutch 120. In other words, the engine clutch actuator 130 engages or disengages the first clutch 120 to transfer the power (the engine power) generated by the engine 110 to driving wheels or block the power transferred to the driving wheels.

For example, the engine clutch actuator 130 engages the first clutch 120 to transfer the power (the engine power) by the engine 110 to the driving wheels, and disengages the first clutch 120 to block the engine power transferred to the driving wheels.

The engine clutch actuator 130 includes a pressure sensor 131 measuring a pressure (hereinafter, referred to as a clutch pressure) of an engine clutch disk. The pressure sensor 131 is mounted in an actuator master cylinder (not illustrated) of the engine clutch actuator 130. The engine clutch actuator 130 transmits the clutch pressure (the measured pressure) measured through the pressure sensor 131 to the controller 190.

The motor 140 receives electric power supplied from the battery 180 to generate power (motor power) and transfers the generated power to the driving wheels. The motor 140 is actuated depending on a control the controller 190, such that an output torque (a motor torque or motor power) is adjusted.

The motor 140 is used as a power generator charging the battery 180 by generating counter electromotive force when a state of charge (SOC) of the battery is insufficient or at the time of regenerative braking. In addition, the motor 140 may also serve to crank the engine 110 in the environmentally friendly vehicle such as the hybrid vehicle.

The second clutch 150 is a double clutch including an odd-shift clutch and an even-shift clutch. For example, the odd-shift clutch transfers the power to an input shaft connected to 1-shift, 3-shift, and 5-shift gears, and the even-shift clutch transfers the power to an input shaft connected to 2-shift, 4-shift, and 6-shift gears.

The odd-shift clutch and the even-shift clutch of the second clutch 150 are engaged or disengaged depending on a control of the controller 190 to transfer the engine torque and/or the motor torque to the transmission 160 or block the engine torque and/or the motor torque transferred to the transmission 160. Although the case in which the controller 190 controls an operation of the second clutch 150 has been described in the present exemplary embodiment, the apparatus for controlling a clutch in an environmentally friendly vehicle according to an exemplary embodiment in the present disclosure is not limited thereto, but may also be implemented to separately include a motor actuator, controlling an operation of the second clutch 150.

The transmission 160 adjusts a gear ratio by gear shifting depending on actuation of the second clutch 150. The transmission 160, which is a double clutch transmission (DCT), changes rotational torques and rotational speeds of the engine and the motor or the motor.

The differential gear 170 is an apparatus appropriately distributing revolutions per minute (RPM) of different wheels and driving the wheels when the wheels move forward or rotate on a rugged portion of a road.

The battery 180, which serves to supply the electric power required for driving the vehicle, is implemented by a high voltage battery.

The controller 190, which is an apparatus controlling the entire driving of the vehicle, generally controls the respective controllers connected through a vehicle network. Here, the vehicle network may be a controller area network (CAN), a FlexRay, a media oriented system transport (MOST) , local interconnection network (LIN), and the like.

The controller 190 switches a driving mode through the engagement or the disengagement of the first clutch 120 and the second clutch 130. The driving mode is divided into an electric vehicle (EV) mode and a hybrid electric vehicle (HEV) mode. The EV mode is a mode in which the engine clutch 120 is disengaged to block the engine power, thereby driving the vehicle by only the motor power, and the HEV mode is a mode in which the engine clutch 120 is engaged, thereby driving the vehicle by the engine power and the motor power.

The controller 190 actuates the engine clutch actuator 130 when the driving mode of the vehicle is switched from the HEV mode into the EV mode. The controller 190 measures the pressure of the engine clutch disk through the pressure sensor 131 of the engine clutch actuator 130.

The controller 190 compares the pressure measured by the pressure sensor 131 with reference data to confirm whether or not abrasion occurs in the engine clutch disk. The controller 190 performs a control compensate for the actuation of the engine clutch 120 depending on an abrasion amount of the engine clutch disk when it is decided that the abrasion occurs in the engine clutch disk.

The reference data, which are pre-stored in a storage (not illustrated), are characteristic information of a clamping load. In other words, the reference data are a clamping load depending on a clamping travel of the engine clutch actuator 130. The clamping load, which is force of a diaphragm spring of the engine clutch 120 a pressure plate, is a load of the pressure plate pressing the clutch disk. The clamping travel is an actuation stroke of the engine clutch required in order to implement a required driving torque of the vehicle.

The present disclosure is to inspect an abrasion state of the engine clutch disk using a feature that the pressure (the clutch pressure) of the engine clutch disk follows the clamping load.

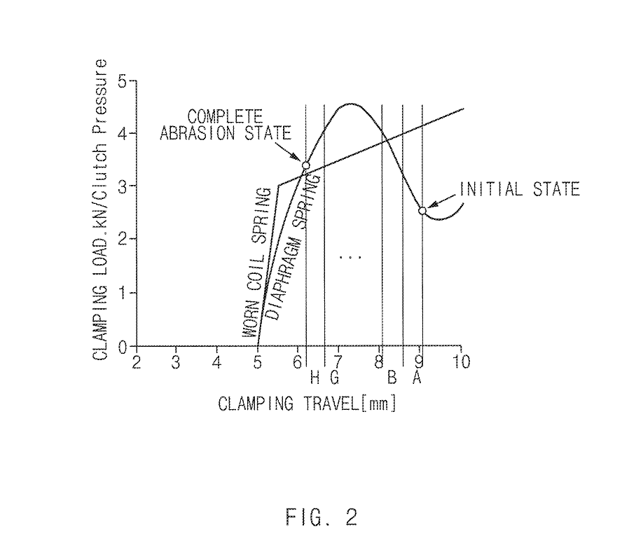

FIG. 2 is a graph illustrating a characteristic curve of a clutch disk-diaphragm spring related to the present disclosure.

An abrasion section of the engine clutch 120 may be divided into a plurality of sections, as illustrated in FIG. 2.

The engine clutch actuator 130 learns a release load of the engine clutch actuator 130 and a clamping load of the engine clutch disk under a constant velocity condition in each section. The engine clutch actuator 130 stores comparison data between the clamping load and the pressure of the engine clutch disk in each section. Here, the engine clutch actuator 130 measures the pressure of the engine clutch disk using the pressure sensor 131.

The engine clutch actuator 130 transfers constantly learned variables and data to the controller 190. When the abrasion occurs in the engine clutch 120, the clamping load is changed as compared with that of an initial state, and thus, an abrasion level of the engine clutch disk may be confirmed. When the abrasion occurs in the engine clutch disk, a pressure of an engine clutch cover follows a characteristic curve of the clamping load in sections A to H.

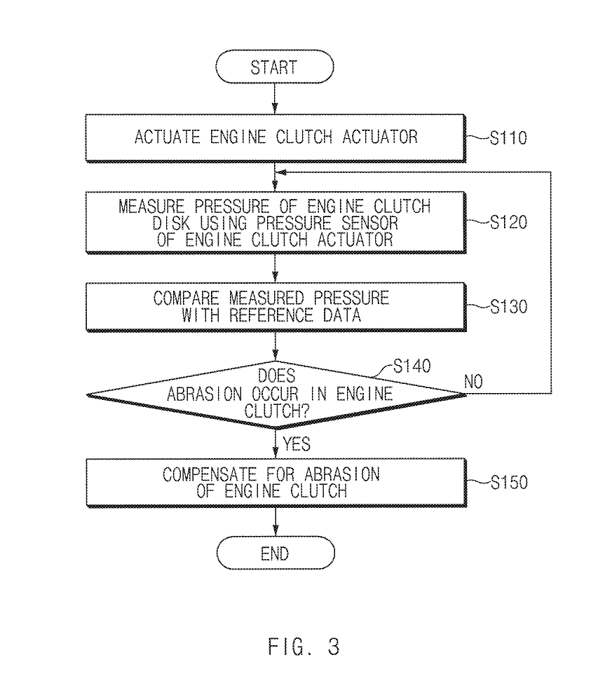

FIG. 3 is a flow chart illustrating a method for controlling a clutch in an environmentally friendly vehicle according to an exemplary embodiment in the present disclosure.

The controller 190 actuates the engine clutch actuator 130 (S110) when the driving mode of the vehicle is switched from the EV mode into the HEV mode. For example, when an SOC of the battery 180 drops to a threshold value or less during a period in which the vehicle is driven in the EV mode, the controller 190 actuates the engine clutch actuator 130 to engage the first clutch 120, thereby switching the driving mode of the vehicle into the HEV mode.

When the driving mode of the vehicle is switched into the HEV mode, the controller 190 measures the pressure of the engine clutch disk (the clutch pressure) using the pressure sensor 131 of the engine clutch actuator 130 (S120).

The controller 190 compares the measured clutch pressure with the reference data (S130). Here, the reference data are the characteristic information of the clamping load depending on the clamping travel. For example, when the clamping travel is 8 mm, the clamping load is 4 kN (kilo Newton). Therefore, it is confirmed whether or not the clutch pressure is 4×101.97 kgf when the clamping travel is 8 mm.

The controller 190 confirms whether or not the abrasion occurs in the first clutch 120 on the basis of the comparison result between the measured clutch pressure and the reference data (S140). For example, the controller 190 confirms whether or not a pressure characteristic curve of the engine clutch 120 moves as compared with the characteristic curve of the clamping load. The controller 190 stores the comparison data between the measured clutch pressure and the reference data in storage (not illustrated) and uses the comparison data as learning data.

The controller 190 performs a control to compensate for the driving of the first clutch 120 on the basis of an abrasion amount of the first clutch 120 (S150) in the case in which the abrasion occurs in the first clutch 120. Here, the controller 190 may calculate an abrasion amount of the first clutch 120 on the basis of a difference between the measured clutch pressure and the reference data. In addition, the controller 190 transmits a rotation command of an actuator motor corresponding to the abrasion amount of the first clutch 120 to the engine clutch actuator 130.

When the abrasion does not occur in the first clutch 120 in S140, the method for controlling a clutch in an environmentally friendly vehicle returns to S120 to measure the clutch pressure and inspect whether or not the abrasion occurs in the first clutch 120 on the basis of the measured clutch pressure.

In the present disclosure, the clutch pressure is sensed using the pressure sensor, the compensation for the abrasion of the clutch is confirmed through a control logic without using a separate abrasion compensation apparatus, and the compensation for the abrasion may be performed through the clutch actuator.

Although the case in which the abrasion state of the engine clutch disk is inspected using the pressure sensor embedded in the engine clutch actuator has been described by way of example in the exemplary embodiments described above, the present disclosure is not limited thereto, but may also be applied to another clutch actuator using a diaphragm.

For example, in the case in which a clutch actuator (not illustrated) controlling an operation of the double clutch in the environmentally friendly vehicle has a pressure sensor embedded therein, the apparatus for controlling a clutch also inspects the abrasion state of the double clutch using the pressure sensor embedded in the clutch actuator.

As described above, according to the exemplary embodiment of the present disclosure, the abrasion station of the clutch disk is confirmed using the pressure sensor of the clutch actuator, and the driving of the clutch is compensated for on the basis of the confirmation result, thereby making it possible to efficiently transfer the power.

In addition, according to the exemplary embodiment in the present disclosure, since the abrasion state of the clutch is inspected using the pressure sensor embedded in the clutch actuator, a separate inspection tool and apparatus are not required.

Further, according to the exemplary embodiment in the present disclosure, drivability and fuel efficiency may be improved due to response characteristics, a consumed current decrease, and the like, depending on compensation for the abrasion of the clutch.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a clutch in an environmentally friendly vehicle, comprising:
a clutch transferring or blocking power generated in a power generator;
a clutch actuator measuring a pressure of the clutch using a pressure sensor embedded therein; and
a controller configured to compare the pressure measured through the pressure sensor with reference data and to inspect whether or not abrasion occurs in the clutch depending on the comparison.

2. The apparatus according to claim 1, wherein the clutch is an engine clutch installed between an engine and a motor and transferring or blocking engine power.

3. The apparatus according to claim 1, wherein the clutch is a double clutch transferring power generated in a motor to a transmission or blocking the power transferred to the transmission.

4. The apparatus according to claim 1, wherein the controller performs compensation for the abrasion of the clutch when the abrasion occurs in the clutch.

5. The apparatus according to claim 4, wherein the controller transmits a rotation command of an actuator motor corresponding to an abrasion amount of the clutch to the clutch actuator.

6. The apparatus according to claim 1, wherein the reference data is characteristic information of a clamping load depending on a clamping travel.

7. The apparatus according to claim 1, wherein the controller stores comparison data between the pressure of the clutch and the reference data in a storage.

8. A method for controlling a clutch in an environmentally friendly vehicle, the method comprising:
actuating a clutch actuator when a driving mode of the environmentally friendly vehicle is switched from a hybrid electric vehicle (HEV) mode into an electric vehicle (EV) mode;
measuring a pressure of the clutch using a pressure senor of the clutch actuator; and
inspecting whether or not abrasion occurs in the clutch by comparing the pressure of the clutch with reference data.

9. The method according to claim 8, further comprising performing compensation for the abrasion of the clutch when the abrasion occurs in the clutch as an inspection result for whether or not the abrasion occurs in the clutch.

10. The method according to claim 9, wherein in the performing of the compensation for the abrasion of the clutch, an abrasion amount of the clutch is calculated on the basis of a comparison result between the pressure of the clutch and the reference data, and a rotation command of an actuator motor corresponding to the calculated abrasion amount of the clutch is transmitted to the clutch actuator.

11. The method according to claim 8, wherein the reference data are characteristic information of a clamping load depending on a clamping travel.

12. The method according to claim 8, wherein in the inspecting of whether or not the abrasion occurs in the clutch, comparison data between the pressure of the clutch and the reference data are stored in a storage.
